(19) United States
(12) Patent Application Publication
(10) Pub. No.: US 2022/0076580 A1
(43) Pub. Date: Mar. 10, 2022

(54) ELECTRONIC DEVICE FOR VEHICLES AND OPERATION METHOD OF ELECTRONIC DEVICE FOR VEHICLES

(71) Applicant: LG ELECTRONICS INC., Seoul (KR)

(72) Inventors: Chanho PARK, Seoul (KR); Kyunghee KIM, Seoul (KR); Taehui YUN, Seoul (KR); Dongha LEE, Seoul (KR); Gaehwan CHO, Seoul (KR); Jooyoung LEE, Seoul (KR)

(73) Assignee: LG ELECTRONICS INC., Seoul (KR)

(21) Appl. No.: 16/500,803

(22) PCT Filed: May 31, 2019
(86) PCT No.: PCT/KR2019/006622

§ 371 Date: Oct. 3, 2019

(51) Int. Cl. G08G 1/00; G06K 9/00; H04L 12/18; G05D 1/02

(52) U.S. Cl. CPC G08G 1/22; G06K 9/00624; G05D 2201/0213; G05D 1/0295; G05D 1/0276; H04L 12/18

(57) ABSTRACT

Disclosed is an electronic device for vehicles included in a vehicle that functions as a lead vehicle during platooning, the electronic device including a processor configured to classify acquired information based on the use thereof, upon determining that the information is first information used in platooning, to assign processing of the first information to a first processor, and upon determining that the information is second information used in monitoring of a platoon, to assign processing of the second information to a second processor.

### TECHNICAL FIELD

The present disclosure relates to an electronic device for vehicles and an operation method of the electronic device for vehicles.

### BACKGROUND ART

A vehicle is an apparatus that moves a passenger in a direction in which the passenger wishes to go. A representative example of the vehicle is a car. An autonomous vehicle means a vehicle capable of automatically traveling without human manipulation.

Meanwhile, a plurality of vehicles may autonomously platoon. In the case in which the vehicles autonomously platoon, platooning may not continue when a communication error occurs due to excess traffic. Also, in the case in which the vehicles platoon, the vehicles must efficiently exchange information with each other.

### DISCLOSURE

### Technical Problem

The present disclosure has been made in view of the above problems, and it is an object of the present disclosure to provide an electronic device for vehicles enabling smooth communication and efficient exchange of information when a plurality of vehicles autonomously platoons.

It is another object of the present disclosure to provide an operation method of an electronic device for vehicles enabling smooth communication and efficient exchange of information when a plurality of vehicles autonomously platoons.

The objects of the present disclosure are not limited to the above-mentioned object, and other objects that have not been mentioned above will become evident to those skilled in the art from the following description.

### Technical Solution

In accordance with an aspect of the present disclosure, the above objects can be accomplished by the provision of an electronic device for vehicles included in a vehicle that functions as a lead vehicle during platooning, the electronic device including a processor configured to classify acquired information based on the use thereof, upon determining that the information is first information used in platooning, to assign processing of the first information to a first processor, and upon determining that the information is second information used in monitoring of a platoon, to assign processing of the second information to a second processor.

According to an embodiment of the present disclosure, the processor may be configured to transmit the first information to at least one other vehicle in the platoon and to receive a first signal corresponding to the first information from the other vehicle through a first signal scheme, and may configured to transmit the second information to the other vehicle and to receive a second signal corresponding to the second information from the other vehicle through a second signal scheme, the second signal scheme being different from the first signal scheme.

According to an embodiment of the present disclosure, the processor may be configured to use the first information in at least one of an operation of generating an autonomous traveling route, an operation of detecting an object outside the platoon, or an operation of generating 3D map data.

According to an embodiment of the present disclosure, the processor may be configured to use the second information in at least one of an operation of adjusting the distance between vehicles in the platoon or an operation of determining whether a control command is reflected.

According to an embodiment of the present disclosure, the first information may be generated based on at least some of first sensing data generated by a first sensor, and the second information may be generated based on at least some of the first sensing data generated by the first sensor.

According to an embodiment of the present disclosure, the processor may be configured to transmit at least one of the first information or the second information to a server and to receive result data generated as the result of processing the transmitted information from the server.

According to an embodiment of the present disclosure, upon determining that a condition of the platoon is changed, the processor may reclassify information acquired after the condition of the platoon is changed based on the use thereof.

According to an embodiment of the present disclosure, the processor may be configured to fuse sensing data received from a plurality of sensors and sensing data of another vehicle received through a communication device in order to acquire information.

According to an embodiment of the present disclosure, the processor may be configured to add vehicle ID data and timestamp data to the first information using the first processor in order to generate first transmission data and to add the vehicle ID data and the timestamp data to the second information using the second processor in order to generate second transmission data.

According to an embodiment of the present disclosure, the processor may be configured to broadcast the first transmission data and the second transmission data.

In accordance with another aspect of the present disclosure, there is provided an operation method of an electronic device for vehicles included in a vehicle that functions as a lead vehicle during platooning, the operation method including at least one processor classifying acquired information based on the use thereof, wherein the classification step includes, upon determining that the information is first information used in platooning, assigning processing of the first information to a first processor and, upon determining that the information is second information used in monitoring of a platoon, assigning processing of the second information to a second processor.

According to an embodiment of the present disclosure, the operation method may further include the at least one processor transmitting the first information to at least one other vehicle in the platoon, the at least one processor receiving a first signal corresponding to the first information from the other vehicle through a first signal scheme, the at least one processor transmitting the second information to the other vehicle, and the at least one processor receiving a second signal corresponding to the second information from the other vehicle through a second signal scheme, the second signal scheme being different from the first signal scheme.

According to an embodiment of the present disclosure, the operation method may further include the at least one processor using the first information in at least one of an operation of generating an autonomous traveling route, an operation of detecting an object outside the platoon, or an operation of generating 3D map data.

According to an embodiment of the present disclosure, the operation method may further include the at least one processor using the second information in at least one of an operation of adjusting the distance between vehicles in the platoon or an operation of determining whether a control command is reflected.

According to an embodiment of the present disclosure, the first information may be generated based on at least some of first sensing data generated by a first sensor, and the second information may be generated based on at least some of the first sensing data generated by the first sensor.

According to an embodiment of the present disclosure, the operation method may further include the at least one processor transmitting at least one of the first information or the second information to a server and the at least one processor receiving result data generated as the result of processing the transmitted information from the server.

According to an embodiment of the present disclosure, the operation method may further include, upon determining that a condition of the platoon is changed, the at least one processor reclassifying information acquired after the condition of the platoon is changed based on the use thereof.

According to an embodiment of the present disclosure, the operation method may further include the at least one processor fusing sensing data received from a plurality of sensors and sensing data of another vehicle received through a communication device in order to acquire information.

According to an embodiment of the present disclosure, the operation method may further include the at least one processor adding vehicle ID data and timestamp data to the first information using the first processor in order to generate first transmission data and the at least one processor adding the vehicle ID data and the timestamp data to the second information using the second processor in order to generate second transmission data.

According to an embodiment of the present disclosure, the operation method may further include the at least one processor broadcasting the first transmission data and the at least one processor broadcasting the second transmission data.

The details of other embodiments are included in the following description and the accompanying drawings.

### Advantageous Effects

According to the present disclosure, one or more of the following effects are provided.

First, information may be classified and processed based on the use thereof, whereby it is possible to easily grasp a data error occurrence cause.

Second, information may be transmitted through a broadcasting scheme, whereby it is possible to reduce malfunction that occurs due to non-reception of information.

It should be noted that effects of the present disclosure are not limited to the effects of the present disclosure as mentioned above, and other unmentioned effects of the present disclosure will be clearly understood by those skilled in the art from the following claims.

### DESCRIPTION OF DRAWINGS

FIG. 1 is a view showing the external appearance of a vehicle according to an embodiment of the present disclosure.

FIG. 2 is a control block diagram of the vehicle according to the embodiment of the present disclosure.

FIG. 3 is a control block diagram of an electronic device for vehicles according to an embodiment of the present disclosure.

FIG. 4 is a flowchart of the electronic device for vehicles according to the embodiment of the present disclosure.

FIGS. 5 and 6 are reference views illustrating a scheme in which information is acquired according to an embodiment of the present disclosure.

FIGS. 7 to 17 are reference views illustrating a communication scheme between vehicles that platoon according to an embodiment of the present disclosure.

### BEST MODE

Hereinafter, the embodiments disclosed in the present specification will be described in detail with reference to the accompanying drawings, and the same or similar elements are denoted by the same reference numerals even though they are depicted in different drawings and redundant descriptions thereof will be omitted. In the following description, with respect to constituent elements used in the following description, the suffixes “module” and “unit” are used or combined with each other only in consideration of ease in the preparation of the specification, and do not have or serve different meanings. Also, in the following description of the embodiments disclosed in the present specification, a detailed description of known functions and configurations incorporated herein will be omitted when it may make the subject matter of the embodiments disclosed in the present specification rather unclear. In addition, the accompanying drawings are provided only for a better understanding of the embodiments disclosed in the present specification and are not intended to limit the technical ideas disclosed in the present specification. Therefore, it should be understood that the accompanying drawings include all modifications, equivalents and substitutions included in the scope and sprit of the present disclosure.

It will be understood that, although the terms “first,” “second,” etc., may be used herein to describe various components, these components should not be limited by these terms. These terms are only used to distinguish one component from another component.

It will be understood that, when a component is referred to as being “connected to” or “coupled to” another component, it may be directly connected to or coupled to another component or intervening components may be present. In contrast, when a component is referred to as being “directly connected to” or “directly coupled to” another component, there are no intervening components present.

As used herein, the singular form is intended to include the plural forms as well, unless the context clearly indicates otherwise.

In the present application, it will be further understood that the terms “comprises,” “includes,” etc. specify the presence of stated features, integers, steps, operations, elements, components, or combinations thereof, but do not preclude the presence or addition of one or more other features, integers, steps, operations, elements, components, or combinations thereof.

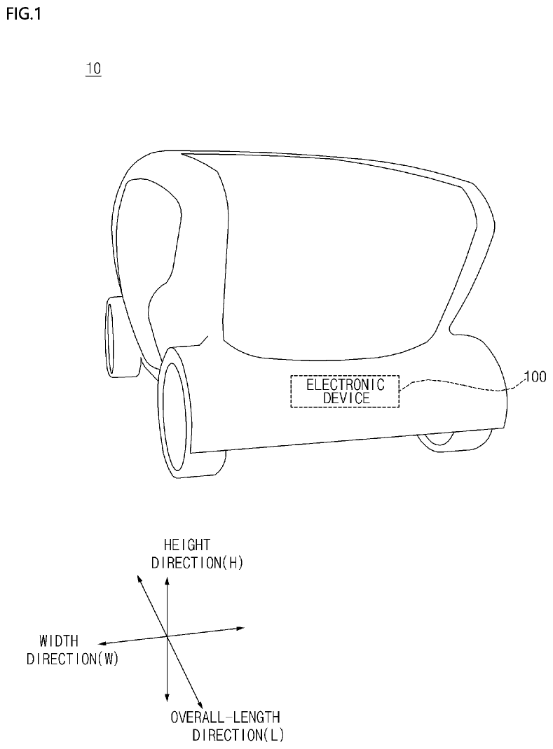

FIG. 1 is a view showing a vehicle according to an embodiment of the present disclosure.

Referring to FIG. 1, the vehicle 10 according to the embodiment of the present disclosure is defined as a transport means that runs on a road or a railway. The vehicle 10 is a concept including a car, a train, and a motorcycle. The vehicle 10 may be a concept including all of an internal combustion engine vehicle including an engine as a power source, a hybrid vehicle including both an engine and an electric motor as a power source, and an electric vehicle including an electric motor as a power source. The vehicle 10 may be a shared vehicle. The vehicle 10 may be an autonomous vehicle.

The vehicle 10 may be one of a plurality of vehicles constituting a platooning system. The platooning system may be described as a group of vehicles that platoon while communicating with each other. The vehicle 10 may be a vehicle that travels at the foremost of the group. In this case, the vehicle 10 may be called a lead vehicle or a master vehicle. In some embodiments, the vehicle 10 may be a vehicle that travels in the middle or at the rearmost of the group. In this case, the vehicle 10 may be called a slave vehicle. The vehicle 10 may include an electronic device 100. The electronic device 100 may be a device that shares information between vehicles when the vehicles platoon.

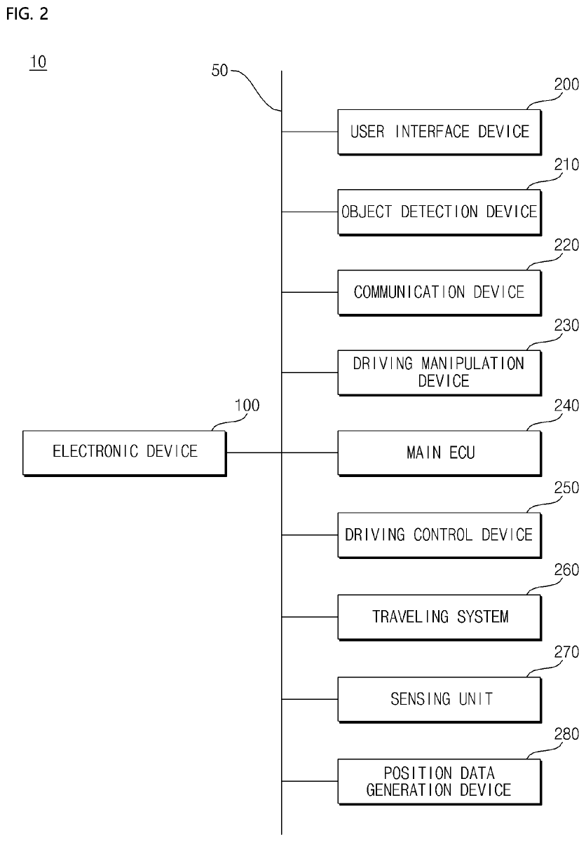

FIG. 2 is a control block diagram of the vehicle according to the embodiment of the present disclosure.

Referring to FIG. 2, the vehicle 10 may include an electronic device 100 for vehicles, a user interface device 200, an object detection device 210, a communication device 220, a driving manipulation device 230, a main ECU 240, a driving control device 250, a traveling system 260, a sensing unit 270, and a position data generation device 280.

The electronic device 100 for vehicles may be included in a vehicle that functions as a lead vehicle during platooning. In some embodiments, the electronic device 100 for vehicles may be included in a following vehicle during platooning. The electronic device 100 for vehicles may be a device that shares information between vehicles that platoon. The electronic device 100 for vehicles may classify acquired information based on the use thereof, and may provide the same to at least one other vehicle constituting a platoon. The electronic device 100 for vehicles may provide information to at least one other vehicle constituting the platoon through local communication. The electronic device 100 for vehicles may provide information to at least one other vehicle constituting the platoon through broadcasting.

The user interface device 200 is a device for communication between the vehicle 10 and the user. The user interface device 200 may receive user input, and may provide information generated by the vehicle 10 to the user. The vehicle 100 may realize a user interface (UI) or a user experience (UX) through the user interface device 200.

The object detection device 210 may detect an object outside the vehicle 10. The object detection device 210 may include at least one sensor for detecting an object outside the vehicle 10. The object detection device 210 may include at least one of a camera, a radar, a lidar, an ultrasonic sensor, an infrared sensor, or a processor. The object detection device 210 may provide data about an object generated based on a sensing signal generated by the sensor to the at least one electronic device included in the vehicle.

The communication device 220 may exchange a signal with a device located outside the vehicle 10. The communication device 220 may exchange a signal with at least one of infrastructure (e.g. a server or a broadcasting station) or another vehicle. The communication device 220 may include at least one of a transmission antenna, a reception antenna, a radio frequency (RF) circuit capable of realizing various communication protocols, or an RF element in order to perform communication.

The driving manipulation device 230 is a device that receives user input for driving. In a manual mode, the vehicle 10 may be operated based on a signal provided by the driving manipulation device 230. The driving manipulation device 230 may include a steering input device (e.g. a steering wheel), an acceleration input device (e.g. an accelerator pedal), and a brake input device (e.g. a brake pedal).

The main ECU 240 may control the overall operation of the at least one electronic device included in the vehicle.

The driving control device 250 is a device that electrically controls various vehicle driving devices in the vehicle 10. The driving control device 250 may include a powertrain driving control device, a chassis driving control device, a door/window driving control device, a safety apparatus driving control device, a lamp driving control device, and an air conditioner driving control device. The powertrain driving control device may include a power source driving control device and a gearbox driving control device. The chassis driving control device may include a steering driving control device, a brake driving control device, and a suspension driving control device.

Meanwhile, the safety apparatus driving control device may include a safety belt driving control device for controlling a safety belt.

The vehicle driving control device 250 may be referred to as a control electronic control unit (ECU).

The traveling system 260 may control the movement of the vehicle 10, or may generate a signal for outputting information to the user, based on data about an object received by the object detection device 210. The traveling system 260 may provide the generated signal to at least one of the user interface device 200, the main ECU 240, or the driving control device 250.

The traveling system 260 may be a concept including an ADAS. The ADAS 260 may realize at least one of an adaptive cruise control (ACC) system, an autonomous emergency braking (AEB) system, a forward collision warning (FCW) system, a lane keeping assist (LKA) system, a lane change assist (LCA) system, a target following assist (TFA) system, a blind spot detection (BSD) system, an adaptive high beam assist (HBA) system, an auto parking system (APS), a pedestrian (PD) collision warning system, a traffic sign recognition (TSR) system, a traffic sign assist (TSA) system, a night vision (NV) system, a driver status monitoring (DSM) system, or a traffic jam assist (TJA) system.

The traveling system 260 may include an autonomous electronic control unit (ECU). The autonomous ECU may set an autonomous traveling route based on data received from at least one of other electronic devices in the vehicle 10. The autonomous ECU may set the autonomous traveling route based on data received from at least one of the user interface device 200, the object detection device 210, the communication device 220, the sensing unit 270, or the position data generation device 280. The autonomous ECU may generate a control signal such that the vehicle 10 travels along the autonomous traveling route. The control signal generated by the autonomous ECU may be provided to at least one of the main ECU 240 or the vehicle driving device 250.

The sensing unit 270 may sense the state of the vehicle. The sensing unit 270 may include at least one of an inertial navigation unit (IMU) sensor, a collision sensor, a wheel sensor, a speed sensor, a slope sensor, a weight sensor, a heading sensor, a position module, a vehicle forward/rearward movement sensor, a battery sensor, a fuel sensor, a tire sensor, a steering wheel rotation sensor, an in-vehicle temperature sensor, an in-vehicle humidity sensor, an ultrasonic sensor, an ambient light sensor, an accelerator pedal position sensor, and a brake pedal position sensor. Meanwhile, the inertial navigation unit (IMU) sensor may include one or more of an acceleration sensor, a gyro sensor, and a magnetic sensor.

The sensing unit 270 may generate vehicle state data based on a signal generated by at least one sensor. The sensing unit 270 may acquire vehicle orientation information, vehicle motion information, vehicle yaw information, vehicle roll information, vehicle pitch information, vehicle collision information, vehicle direction information, vehicle angle information, vehicle speed information, vehicle acceleration information, vehicle tilt information, vehicle forward/rearward movement information, battery information, fuel information, tire information, vehicle lamp information, in-vehicle temperature information, in-vehicle humidity information, and a sensing signal, such as a steering wheel rotation angle, ambient light outside the vehicle, pressure applied to an accelerator pedal, and pressure applied to a brake pedal.

In addition, the sensing unit 270 may further include an accelerator pedal sensor, a pressure sensor, an engine speed sensor, an air flow sensor (AFS), an air temperature sensor (ATS), a water temperature sensor (WTS), a throttle position sensor (TPS), a TDC sensor, and a crank angle sensor (CAS).

The sensing unit 270 may generate vehicle state information based on sensing data. The vehicle state information may be information generated based on data sensed by various sensors provided in the vehicle.

For example, the vehicle state information may include vehicle orientation information, vehicle speed information, vehicle tilt information, vehicle weight information, vehicle direction information, vehicle battery information, vehicle fuel information, information about the air pressure of tires of the vehicle, vehicle steering information, in-vehicle temperature information, in-vehicle humidity information, pedal position information, and vehicle engine temperature information.

Meanwhile, the sensing unit may further include a tension sensor. The tension sensor may generate a sensing signal based on the tension state of the safety belt.

The position data generation device 280 may generate position data of the vehicle 10. The position data generation device 280 may include at least one of a global positioning system (GPS) or a differential global positioning system (DGPS). The position data generation device 280 may generate position data of the vehicle 10 based on a signal generated by at least one of the GPS or the DGPS. In some embodiments, the position data generation device 280 may correct position data based on at least one of an inertia measurement unit (IMU) of the sensing unit 270 or the camera of the object detection device 210.

The position data generation device 280 may be referred to as a positioning device. The position data generation device 280 may be referred to as a global navigation satellite system (GLASS).

The vehicle 10 may include an internal communication system 50. A plurality of electronic devices included in the vehicle 10 may exchange signals with each other via the internal communication system 50. The signal may include data. The internal communication system 50 may use at least one communication protocol (e.g. CAN, LIN, FlexRay, MOST, or Ethernet).

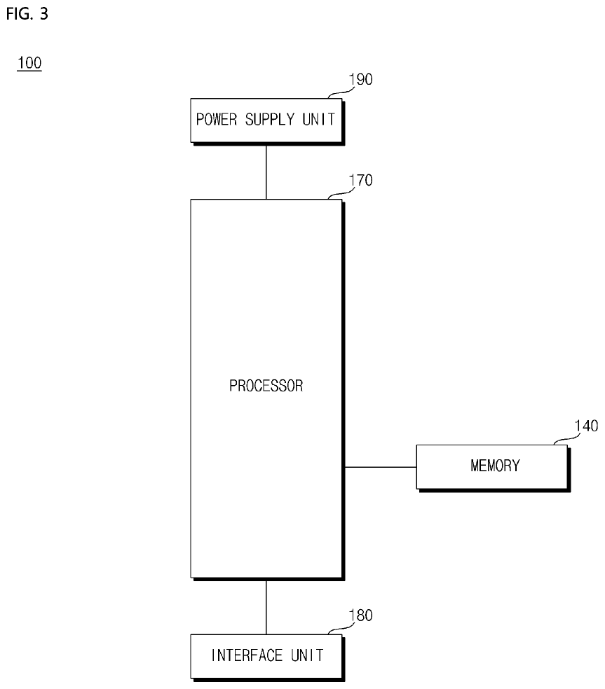

FIG. 3 is a control block diagram of an electronic device according to an embodiment of the present disclosure.

Referring to FIG. 3, the electronic device 100 may include a memory 140, a processor 170, an interface unit 180, and a power supply unit 190.

The memory 140 is electrically connected to the processor 170. The memory 140 may store basic data about the units, control data necessary to control the operation of the units, and data that are input and output. The memory 140 may store data processed by the processor 170. In a hardware aspect, the memory 140 may be constituted by at least one of a ROM, a RAM, an EPROM, a flash drive, or a hard drive. The memory 140 may store various data necessary to perform the overall operation of the electronic device 100, such as a program for processing or control of the processor 170. The memory 140 may be integrated into the processor 170. In some embodiments, the memory 140 may be classified as a low-level component of the processor 170.

The interface unit 180 may exchange a signal with the at least one electronic device provided in the vehicle 10 in a wired or wireless fashion. The interface unit 180 may exchange a signal with at least one of the user interface device 200, the object detection device 210, the communication device 220, the driving manipulation device 230, the main ECU 240, the driving control device 250, the ADAS 260, the sensing unit 270, or the position data generation device 280 in a wired or wireless fashion. The interface unit 180 may be constituted by at least one of a communication module, a terminal, a pin, a cable, a port, a circuit, an element, or a device.

The interface unit 180 may receive position data of the vehicle 10 from the position data generation device 280. The interface unit 180 may receive traveling speed data from the sensing unit 270. The interface unit 180 may receive data about an object around the vehicle from the object detection device 210.

The power supply unit 190 may supply power to the electronic device 100. The power supply unit 190 may receive power from a power source (e.g. a battery) included in the vehicle 10, and may supply the received power to the respective units of the electronic device 100. The power supply unit 190 may be operated according to a control signal provided from the main ECU 240. For example, the power supply unit 190 may be realized as a switched-mode power supply (SMPS).

The processor 170 may be electrically connected to the memory 140, the interface unit 180, and the power supply unit 190 in order to exchange a signal therewith. The processor 170 may be realized using at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or electrical units for performing other functions.

The processor 170 may be driven by power provided by the power supply unit 190. In the state of receiving power provided by the power supply unit 190, the processor 170 may receive data, may process the data, may generate a signal, and may provide the signal.

The processor 170 may receive information from another electronic device in the vehicle 10 through the interface unit 180. The processor 170 may provide a control signal to another electronic device in the vehicle 10 through the interface unit 180.

The processor 170 may acquire information. The processor 170 may receive sensing data from a plurality of sensors included in the object detection device 210. The processor 170 may receive sensing data of another vehicle constituting the platoon from the other vehicle through the communication device 220. The processor 170 may fuse the sensing data of the vehicle 10 and the sensing data of the other vehicle in order to generate information. For example, the processor 170 may fuse first sensing data of the vehicle 10, which travels at the front of the platoon, second sensing data of another vehicle that travels in the middle of the platoon, and third sensing data of another vehicle that travels at the rear of the platoon in order to generate first information. At this time, the first sensing data, the second sensing data, and the third sensing data may be sensing data acquired by sensors facing outside the platoon. For example, the processor 170 may fuse fourth sensing data of the vehicle 10, which travels at the front of the platoon, fifth sensing data of the other vehicle that travels in the middle of the platoon, and sixth sensing data of the other vehicle that travels at the rear of the platoon in order to generate second information. At this time, the fourth sensing data, the fifth sensing data, and the sixth sensing data may be sensing data acquired by sensors facing inside the platoon.

The processor 170 may classify acquired information based on the use thereof. Upon determining that the acquired information is first information used in platooning, the processor 170 may assign processing of the first information to a first processor. The first information may be defined as information necessary to control platooning. For example, the first information may be information necessary to generate an autonomous traveling route. For example, the first information may be information necessary to detect an object outside a vehicle (or the platoon). For example, the first information may be information necessary to generate 3D map information. The first information may be information based on sensing data generated by sensors for sensing the outside of the platoon. The first processor may be classified as a low-level component of the processor 170. The first processor may be constituted by separate hardware, such as a microprocessor, or a software block.

Upon determining that the acquired information is second information used in monitoring of the platoon, the processor 170 may assign processing of the second information to a second processor. The second information may be defined as information necessary to manage the platoon. For example, the second information may be information necessary to adjust the distance between the vehicles in the platoon. For example, the second information may be information necessary to determine whether a control command generated by the vehicle 10 is reflected in another vehicle. The second information may be information based on sensing data generated by sensors for sensing the inside of the platoon. The second processor may be classified as a low-level component of the processor 170. The second processor may be constituted by separate hardware, such as a microprocessor, or a software block.

Meanwhile, in some embodiments, the second information may be control command information generated by the processor 170. For example, the second information may include a steering control command, an acceleration control command, and a deceleration control command.

The processor 170 may divide a plurality of sensors into a first sensor group for acquiring first information and a second sensor group for acquiring second information. For example, the processor 170 may classify sensors that do not detect the vehicles constituting the platoon, among a plurality of sensors, as a first sensor group. For example, the processor 170 may classify sensors that detect the vehicles constituting the platoon, among a plurality of sensors, as a second sensor group. The first sensor group may be constituted by a combination of a plurality of sensors provided in several vehicles in the platoon. The second sensor group may be constituted by a combination of a plurality of sensors provided in several vehicles in the platoon. The processor 170 may classify information received from the first sensor group as first information, and may classify information received from the second sensor group as second information.

The processor 170 may divide a sensing area of one of the sensors into a first area and a second area. For example, the processor 170 may set a portion of the entire sensing area in which the vehicles constituting the platoon are not detected as the first area. For example, the processor 170 may set a portion of the entire sensing area in which the vehicles constituting the platoon are detected as the second area. The processor 170 may classify information about the first area as the first information, and may classify information about the second area as the second information.

The processor 170 may transmit the first information to at least one other vehicle in the platoon. For example, the processor 170 may transmit the first information to at least one other vehicle in the platoon through a first signal scheme. The processor 170 may receive a first signal corresponding to the first information through the first signal scheme. The processor 170 may transmit the second information to at least one other vehicle in the platoon. For example, the processor 170 may transmit the second information to at least one other vehicle in the platoon through a second signal scheme. The processor 170 may receive a second signal corresponding to the second information from at least one other vehicle in the platoon through the second signal scheme. The second signal scheme may be different from the first signal scheme. For example, the second signal scheme may be different in at least one of reception cycle, reception form, or reception frequency from the first signal scheme.

The processor 170 may use the first information in at least one of an operation of generating an autonomous traveling route, an operation of detecting an object outside the platoon, or an operation of generating 3D map data.

The processor 170 may use the second information in at least one of an operation of adjusting the distance between vehicles in the platoon or an operation of determining whether a control command is reflected.

The first information may be generated based on at least some of first sensing data generated by the first sensors. The second information may be generated based on at least some of the first sensing data generated by the first sensors. For example, the first information and the second information may be based on data acquired by sensors that face the rear of the vehicle 10. The first information may be based on sensing data of an area excluding an area occupied by the platoon, among the data acquired by the sensors that faces the rear of the vehicle 10. The second information may be based on sensing data of the area occupied by the platoon, among the data acquired by the sensors that face the rear of the vehicle 10.

The processor 170 may transmit at least one of the first information or the second information to a server. The server may be an autonomous traveling control server. The server may perform an operation of generating an autonomous traveling route, an operation of detecting an object outside the platoon, and an operation of generating 3D map data based on the received first information. The server may provide result data of the operation of generating the autonomous traveling route, the operation of detecting the object outside the platoon, and the operation of generating the 3D map data to the vehicle 10. The processor 170 may receive result data generated as the result of processing the transmitted information from the server.

Upon determining that the condition of the platoon is changed, the processor 170 may reclassify information acquired after the condition of the platoon is changed based on the use thereof. The change in the condition of the platoon may be described as the condition in which at least one of the vehicles constituting the platoon is separated from the platoon or the condition in which at least one external vehicle joins the platoon. Alternatively, the change in the condition of the platoon may be described as the condition in which at least one of the vehicles constituting the platoon performs an emergency function.

The processor 170 may fuse sensing data received from a plurality of sensors and sensing data of another vehicle received through the communication device 220 in order to acquire information. The sensors may be included in the object detection device 210.

The processor 170 may add identification (ID) data and timestamp data of the vehicle that has generated the first information to the first information using the first processor in order to generate first transmission data. The processor 170 may add ID data and timestamp data of the vehicle that has generated the second information to the second information using the second processor in order to generate second transmission data.

The processor 170 may broadcast the first transmission data and the second transmission data. The processor 170 may transmit the first transmission data and the second transmission data to the vehicles constituting the platoon. A vehicle that receives data may retransmit the received data to another vehicle. The electronic device 100 may include at least one printed circuit board (PCB). The memory 140, the interface unit 180, the power supply unit 190, and the processor 170 may be electrically connected to the printed circuit board.

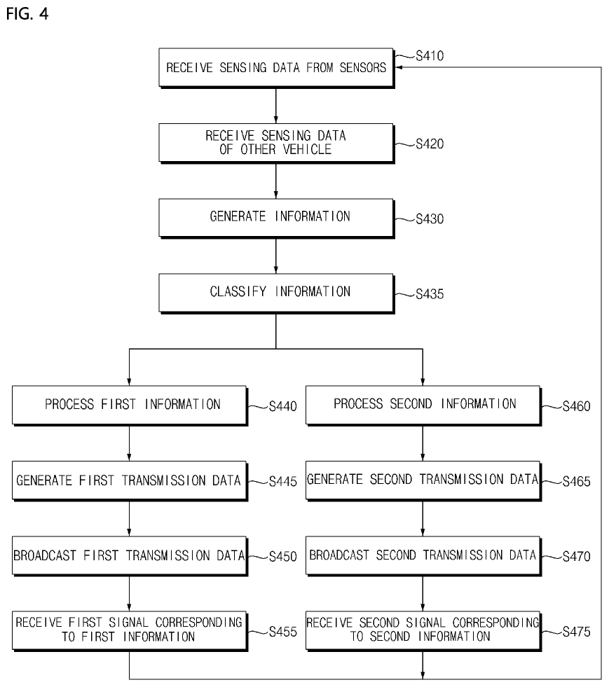

FIG. 4 is a flowchart of the electronic device for vehicles according to the embodiment of the present disclosure. FIG. 4 is referred to in order to describe respective steps of an operation method of the electronic device for vehicles.

Referring to FIG. 4, the processor 170 may receive sensing data from a plurality of sensors through the interface unit 180 (S410). The processor 170 may receive sensing data of another vehicle in the platoon from the other vehicle through the communication device 220 (S420).

The processor 170 may generate information based on the sensing data of the vehicle 10 and the sensing data of the other vehicle (S430). The processor 170 may fuse the sensing data from the sensors and the sensing data of the other vehicle received through the communication device 220 in order to acquire information. For example, the processor 170 may fuse first sensing data of the vehicle 10, which travels at the front of the platoon, second sensing data of another vehicle that travels in the middle of the platoon, and third sensing data of another vehicle that travels at the rear of the platoon in order to generate first information. At this time, the first sensing data, the second sensing data, and the third sensing data may be sensing data acquired by sensors facing outside the platoon. For example, the processor 170 may fuse fourth sensing data of the vehicle 10, which travels at the front of the platoon, fifth sensing data of the other vehicle that travels in the middle of the platoon, and sixth sensing data of the other vehicle that travels at the rear of the platoon in order to generate second information. At this time, the fourth sensing data, the fifth sensing data, and the sixth sensing data may be sensing data acquired by sensors facing inside the platoon. The processor 170 may classify acquired information based on the use thereof (S435). The classification step (S435) may include a step of, upon determining that the information is first information used in platooning, assigning processing of the first information to the first processor and a step of, upon determining that the information is second information used in monitoring of the platoon, assigning processing of the second information to the second processor.

Meanwhile, the operation method of the electronic device for vehicles may further include a step of at least one processor 170 transmitting the first information to at least one other vehicle in the platoon, a step of the at least one processor 170 receiving a first signal corresponding to the first information from the other vehicle through a first signal scheme, a step of the at least one processor 170 transmitting the second information to the other vehicle, and a step of the at least one processor 170 receiving a second signal corresponding to the second information from the other vehicle through a second signal scheme, which is different from the first signal scheme.

The information classification step (S435) may include a step of the at least one processor 170 dividing a plurality of sensors into a first sensor group for acquiring the first information and a second sensor group for acquiring the second information and a step of the at least one processor 170 classifying information received from the first sensor group as the first information and classifying information received from the second sensor group as the second information.

The information classification step (S435) may include a step of the at least one processor 170 dividing a sensing area of one of the sensors into a first area and a second area and a step of the at least one processor 170 classifying information about the first area as the first information and classifying information about the second area as the second information.

The processor 170 may process the first information using the first processor (S440). For example, the processor 170 may use the first information in at least one of an operation of generating an autonomous traveling route, an operation of detecting an object outside the platoon, or an operation of generating 3D map data. Meanwhile, the first information may be generated based on at least some of the first sensing data generated by the first sensors.

The processor 170 may generate first transmission data based on the first information (S445). The processor 170 may add identification (ID) data and timestamp data of the vehicle to the first information using the first processor in order to generate first transmission data.

The processor 170 may broadcast the first transmission data to another vehicle constituting the platoon (S450). The processor 170 may receive a first signal corresponding to the first information from the other vehicle constituting the platoon (S455).

The processor 170 may process the second information using the second processor (S460). For example, the processor 170 may use the second information in at least one of an operation of adjusting the distance between vehicles in the platoon or an operation of determining whether a control command is reflected. Meanwhile, the second information may be generated based on at least some of the first sensing data generated by the first sensors.

The processor 170 may generate second transmission data based on the second information (S465). The processor 170 may add ID data and timestamp data of the vehicle to the second information using the first processor in order to generate second transmission data.

The processor 170 may broadcast the second transmission data to another vehicle constituting the platoon (S470). The processor 170 may receive a second signal corresponding to the second information from the other vehicle constituting the platoon (S475).

The operation method of the electronic device for vehicles may further include a step of at least one processor 170 transmitting at least one of the first information or the second information to the server and a step of at least one processor 170 receiving result data generated as the result of processing the transmitted information from the server.

The operation method of the electronic device for vehicles may further include a step of reclassifying information acquired after the condition of the platoon is changed based on the use thereof upon determining that the condition of the platoon is changed.

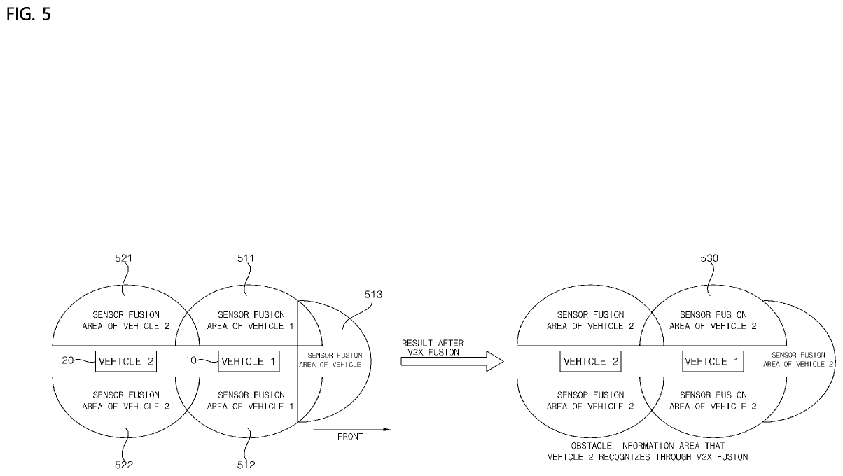

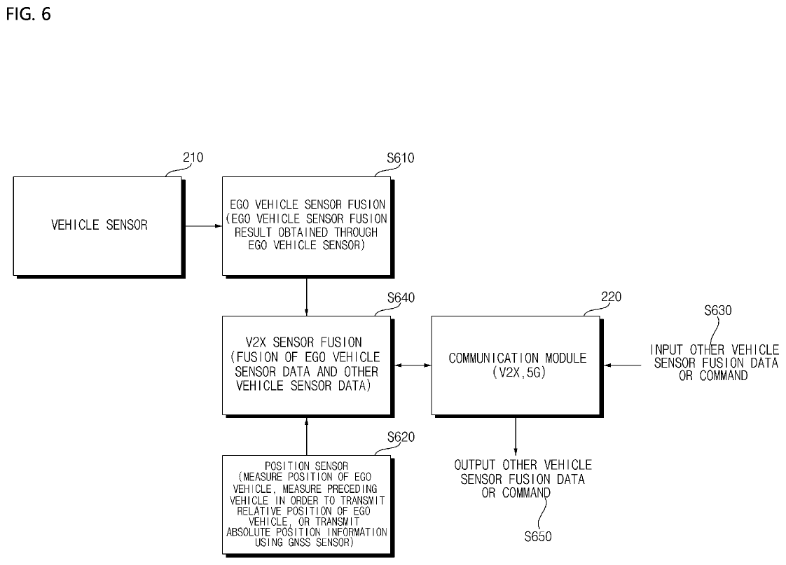

FIGS. 5 and 6 are reference views illustrating a scheme in which information is acquired according to an embodiment of the present disclosure.

Referring to FIG. 5, the processor 170 may receive sensing data about a plurality of areas 511, 512, and 513 from the sensors of the object detection device 210 through the interface unit 180. The processor 170 may receive sensing data about a plurality of areas 521 and 522 generated by a plurality of sensors of another vehicle 20 constituting the platoon from the other vehicle 20 through the communication device 220. The processor 170 may fuse the sensing data about the areas 511, 512, and 513 around the vehicle 10 and the sensing data about the areas 521 and 522 around the other vehicle 20 in order to generate fusion sensing data. The fusion sensing data may be sensing data about an area around the platoon.

In general, a following vehicle may not recognize the status of the front of the platoon during platooning. The following vehicle may also recognize the status of the front of the platoon through the electronic device 100 according to the embodiment of the present disclosure. It is possible to acquire relatively much sensor information using a small number of sensors through the electronic device 100 according to the embodiment of the present disclosure. For accurate sensor fusion, an algorithm for acquiring position information of the other vehicle 20, which constitutes the platoon together with the vehicle 10, is necessary. In the case in which an abrupt obstacle occurs in front of the vehicle 10, the other vehicle 20 may determine avoidance of the obstacle in advance through the electronic device 100 according to the embodiment of the present disclosure. The other vehicle 20 may perform platooning using a small number of sensors. The vehicle 10 may recognize the state of the rear thereof using the sensor information of the other vehicle 20. As a result, the vehicle 10 may more safely determine lane change, acceleration, and deceleration. A user may easily monitor obstacle information of all of the vehicles during platooning, which may stably contribute to the mental state of the user. Even in the case in which any one sensor malfunctions during platooning, a problem may be explained using a sensor of another vehicle, whereby a safety function may be improved. The platooning group may acquire information about all obstacles through sensor fusion using a V2X module (a communication module). Referring to FIG. 6, the processor 170 may receive sensing data from a plurality of sensors 210. The processor 170 may fuse the sensing data received from the sensors 210 (S610).

The processor 170 may acquire position data (S620). The processor 170 may acquire position data of the vehicle from the position data generation device 280. The processor 170 may acquire position data of another vehicle based on the position data of the vehicle 10 and the sensing data received from the sensors 210. Alternatively, the processor 170 may acquire position data of the other vehicle from the other vehicle.

The processor 170 may receive the position data of the other vehicle from the other vehicle through the communication module 220 (S630).

The processor 170 may fuse the sensing data of the vehicle 10 and the sensing data of the other vehicle based on the position data of the vehicle 10 and the position data of the other vehicle in order to generate fusion data (S640).

The processor 170 may transmit the fusion data to other vehicles constituting the platoon through the communication device 220 (S650). The processor 170 may transmit a control command to the other vehicles constituting the platoon through the communication device 220.

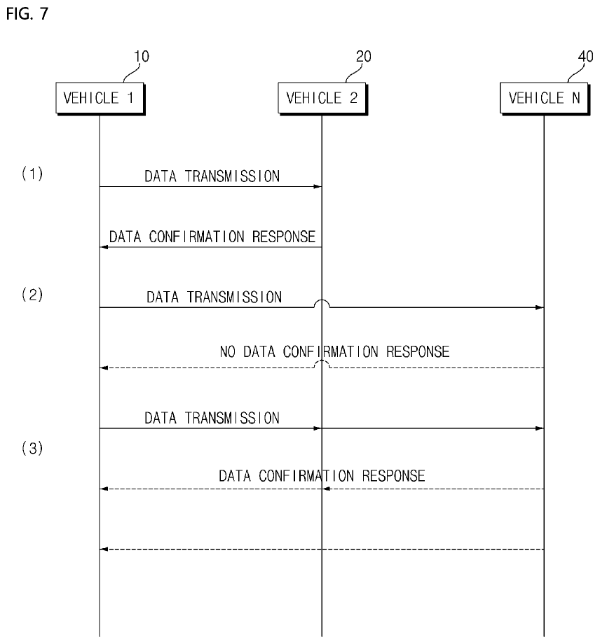

FIGS. 7 to 17 are reference views illustrating a communication scheme between vehicles that platoon according to an embodiment of the present disclosure.

Referring to FIG. 7, a plurality of platooned vehicles may exchange information, data, and signals with each other using a mobile communication network (e.g. a 4G network or a 5G network). The platooned vehicles may exchange information, data, and signals with each other through local communication. The local communication may be described as a scheme in which information, data, and signals are directly exchanged between platooned vehicles using a predetermined communication scheme (e.g. Wi-Fi). In the case in which local communication is used, it is possible to exchange information, data, and signals more rapidly than in the case in which the mobile communication network is used, whereby the distance between the platooned vehicles may be formed so as to be short. In this case, the size of the platoon may be relatively small.

The vehicle 10 may transmit data to a first other vehicle 20, and may receive a data confirmation response message. In the case in which a second other vehicle 40 is far away from the vehicle 10 or is jammed, the vehicle 10 may not receive a data confirmation response message even when the vehicle 10 transmits data to the second other vehicle 40.

The vehicle 10 may transmit data to the first other vehicle 20, and the first other vehicle 20 may retransmit received data to the second other vehicle 40.

The first other vehicle 20 may receive a data confirmation response message from the second other vehicle 40, and may retransmit the same to the vehicle 10. In this case, data transmission may be delayed, and platooning becomes impossible when the first other vehicle 20 has communication difficulty.

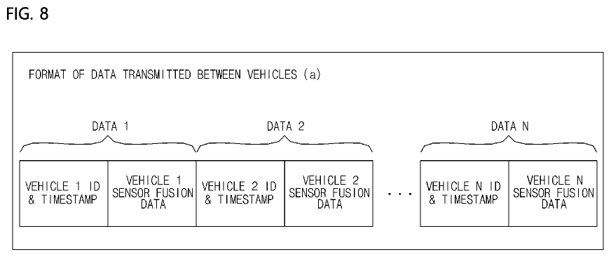

Referring to FIG. 8, each of a plurality of vehicles constituting a platoon may broadcast data thereof while carrying data received from another vehicle at the previous sampling time. In this case, fusion data in the previous frame may be used even when no data are transmitted from any one vehicle due to communication jamming or a specific system error, whereby a problem may be solved. In the case in which data are not updated in a specific vehicle, each vehicle may recognize that a communication problem occurs, and may perform traveling suitable for the situation, or may inform the user thereof or transmit the state thereof to the server such that an emergency measure is performed. All vehicles constituting the platoon may recognize the vehicle having a communication problem through comparison in difference between timestamps of the data.

FIG. 8 exemplarily shows the format of data transmitted and received between the vehicles constituting the platoon. The data may be formed by combining ID data and timestamp data of the vehicle that has generated the fusion data with the fusion data.

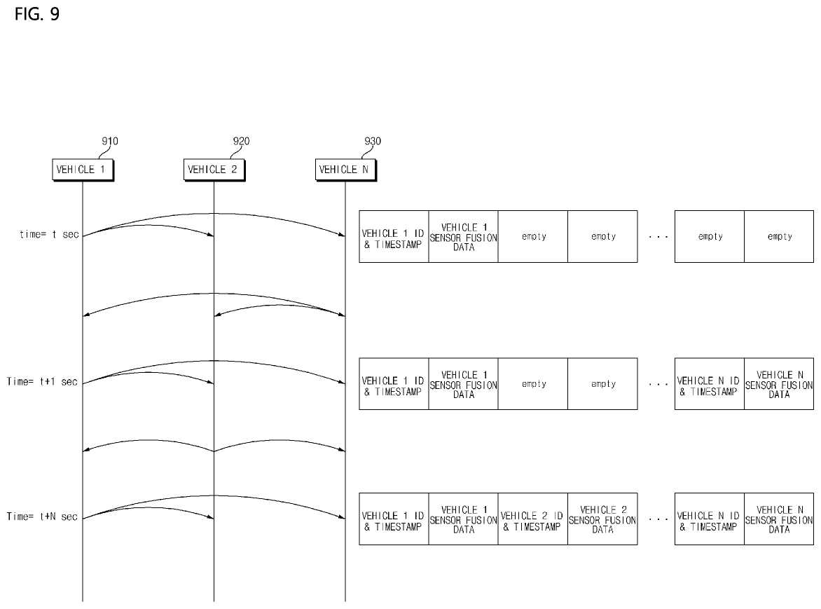

Referring to FIG. 9, a first vehicle 910, a second vehicle 920, and a third vehicle 930 may platoon. The first vehicle 910 may be classified as a vehicle 10, and the second vehicle 920 and the third vehicle 930 may be classified as other vehicles. Meanwhile, an operation of generating data, an operation of transmitting data, and an operation of receiving data may be performed by the processor 170 of the electronic device 100 for vehicles.

At time t, the first vehicle 910 may broadcast first transmission data. As previously described, the first transmission data may include ID data and timestamp data of the first vehicle in fusion data generated at time t (or immediately before time t). Meanwhile, at time t, the first vehicle 910 may receive transmission data generated by the third vehicle 930 from the third vehicle.

At time t+1, the first vehicle 910 may broadcast second transmission data. The second transmission data may include ID data and timestamp data of the first vehicle in fusion data generated at time t+1 (or immediately before time t+1). In addition, the second transmission data may include transmission data generated by the third vehicle, received at time t. Meanwhile, at time t+1, the first vehicle 910 may receive transmission data generated by the second vehicle 920 from the second vehicle.

At time t+2, the first vehicle 910 may broadcast third transmission data. The third transmission data may include ID data and timestamp data of the first vehicle in fusion data generated at time t+2 (or immediately before time t+2). In addition, the third transmission data may include transmission data generated by the third vehicle 930, received at time t, and transmission data generated by the second vehicle 920, received at time t+1.

As described above, each vehicle transmits fusion data generated by another vehicle in the state of including ID data and timestamp data as well its own fusion data, whereby it is possible to share data even in the state in which a specific vehicle has communication difficulty and to rapidly recognize the vehicle having communication difficulty.

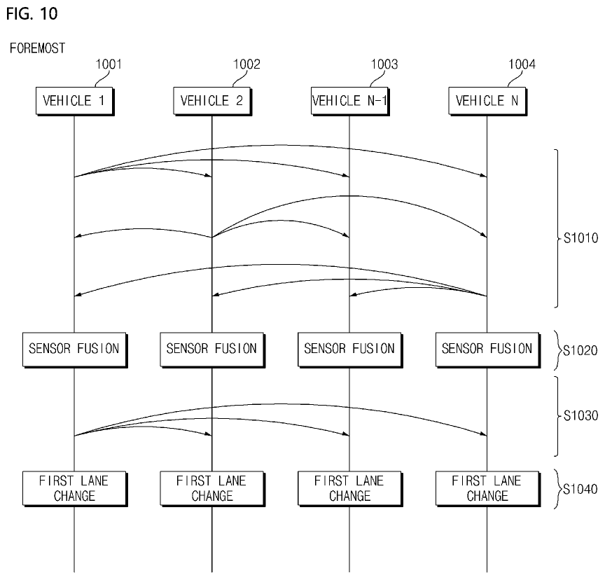

Referring to FIG. 10, a first vehicle 1001, a second vehicle 1002, a third vehicle 1003, and a fourth vehicle 1004 may platoon. The first vehicle 1001 may be classified as a vehicle 10, and the second vehicle 1002, the third vehicle 1003, and the fourth vehicle 1004 may be classified as other vehicles. Meanwhile, an operation of generating data, an operation of transmitting data, and an operation of receiving data may be performed by the processor 170 of the electronic device 100 for vehicles.

Each of the vehicles 1001, 1002, 1003, and 1004 included in a platoon may transmit fusion data and position data to another vehicle (S1010). In the case in which the number of vehicles included in the platoon is large and thus communication distance is increased, a vehicle traveling in the middle of the platoon may transmit data.

Each of the vehicles 1001, 1002, 1003, and 1004 included in the platoon may fuse data received from another vehicle with its own data in order to generate fusion data (S1020).

The first vehicle 1001 may broadcast a lane change command signal (S1030). At this time, a vehicle located in the middle of the platoon may update the lane change command of the first vehicle 1001, and may broadcast the same to the following vehicle.

Each of the vehicles 1001, 1002, 1003, and 1004 included in the platoon may change lanes (S1040). The fourth vehicle 1004, which travels at the rearmost of the platoon, may change lanes first. A vehicle that travels in the state of being closer to the rear of the platoon may change lanes earlier. The speed of the vehicle that has changed lanes may be reduced such that a preceding vehicle can easily change lanes. The first vehicle 1001, which travels at the foremost of the platoon, may change lanes last.

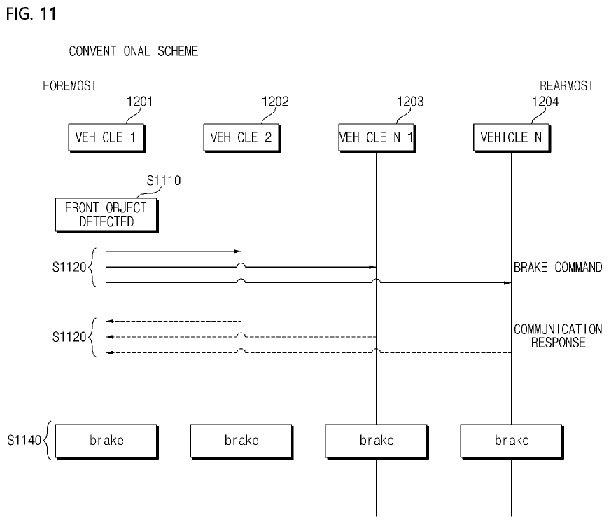

Referring to FIG. 11, the shorter the distance between vehicles during platooning, the higher energy efficiency but the higher the danger of an accident at the time of a sudden stop. Reducing communication latency between the vehicles is related to platooning performance. According to the present disclosure, it is possible to simultaneously brake the vehicles that acquire sensor fusion data of the entirety of a platooning group.

FIG. 11 shows a conventional braking operation of platooning. When an obstacle in front of the platoon is detected (S1110), a first vehicle 1201, which travels at the foremost of the platoon, may transmit a brake command signal to a second vehicle 1202, a third vehicle 1203, and a fourth vehicle 1204 (S1120). The first vehicle 1201 may receive a response signal from the second vehicle 1202, the third vehicle 1203, and the fourth vehicle 1204. The first to fourth vehicles 1201, 1202, 1203, and 1204 may perform a braking operation. In the case in which the length of the platoon is increased, the communication distance between the first vehicle 1201, which is located at the foremost of the platoon, and the fourth vehicle 1204, which is located at the rearmost of the platoon, is increased. In this case, a vehicle that travels in the middle of the platoon may serve as a communication bridge. In the case in which communication jamming or an error occurs in the vehicle serving as the communication bridge, platooning may become dangerous.

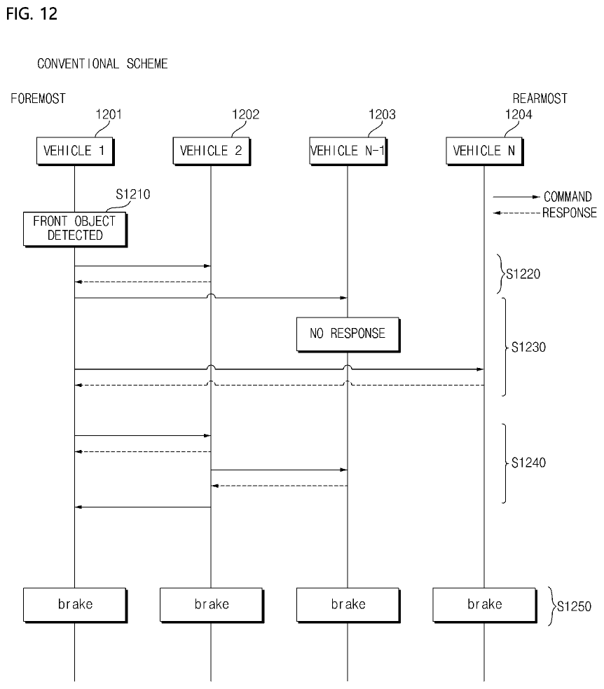

Referring to FIG. 12, in the case in which a communication error occurs due to communication jamming or a long distance between vehicles, the first vehicle 1201 must retransmit a command signal, and must receive a response. In the case in which the distance between the vehicles is long, the first vehicle must retransmit a command signal through another vehicle serving as the bridge. In this case, responsiveness may become slow, and stability of the entire platooning system may be deteriorated.

FIG. 12 shows a conventional braking operation of platooning. When an obstacle in front of the platoon is detected (S1210), the first vehicle 1201, which travels at the foremost of the platoon, may transmit a brake command signal to the second vehicle 1202, the third vehicle 1203, and the fourth vehicle 1204 (S1220 and S1230). In the case in which a response signal is not received from the third vehicle 1203 due to a communication error, etc., the first vehicle 1201 may transmit a brake command signal to the third vehicle 1203 via the second vehicle 1202. The first to fourth vehicles 1201, 1202, 1203, and 1204 may perform a braking operation (S1250). In this case, time is necessary at step S1240, whereby stability of the entire platooning system may be deteriorated.

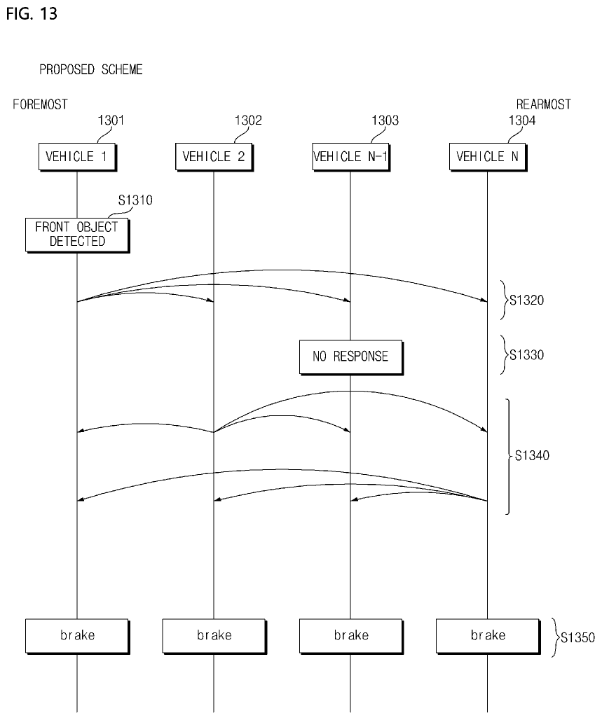

Referring to FIG. 13, all vehicles in a platoon transmit transmission data in the state of including ID data, timestamp data, sensor fusion data, command data, and response data to the command using a broadcasting scheme. At each sampling time, data received from other vehicles are updated in order to broadcast data about all of the vehicles. Even in the case in which data are temporarily lost due to a communication error, etc. on the way, all data may be used. In addition, even in the case in which the distance between a first vehicle 1301, which is located at the foremost of the platoon, and a fourth vehicle 1304, which is located at the rearmost of the platoon, is long, no vehicle serving a bridge is necessary, since vehicles that travel in the middle of the platoon update data of adjacent vehicles.

When an obstacle in front of the platoon is detected (S1310), the first vehicle 1201, which travels at the foremost of the platoon, may transmit a brake command signal to a second vehicle 1202, a third vehicle 1203, and the fourth vehicle 1204 (S1320 and S1330).

A response signal may not be received from the third vehicle 1203 due to a communication error, etc. Even in this case, the second vehicle 1302 and the fourth vehicle 1304 may transmit the brake command signal to the third vehicle 1303 using a broadcasting scheme (S1340). The first to fourth vehicles 1201, 1202, 1203, and 1204 may perform a braking operation (S1350).

Since the brake command signal generated by the first vehicle 1201 is received from the second vehicle 1202 and the fourth vehicle 1204 as well as the first vehicle 1201, the third vehicle 1203 may receive the brake command signal. Since the brake command signal is transmitted and received organically, as described above, the stability of the entire platooning system may be improved.

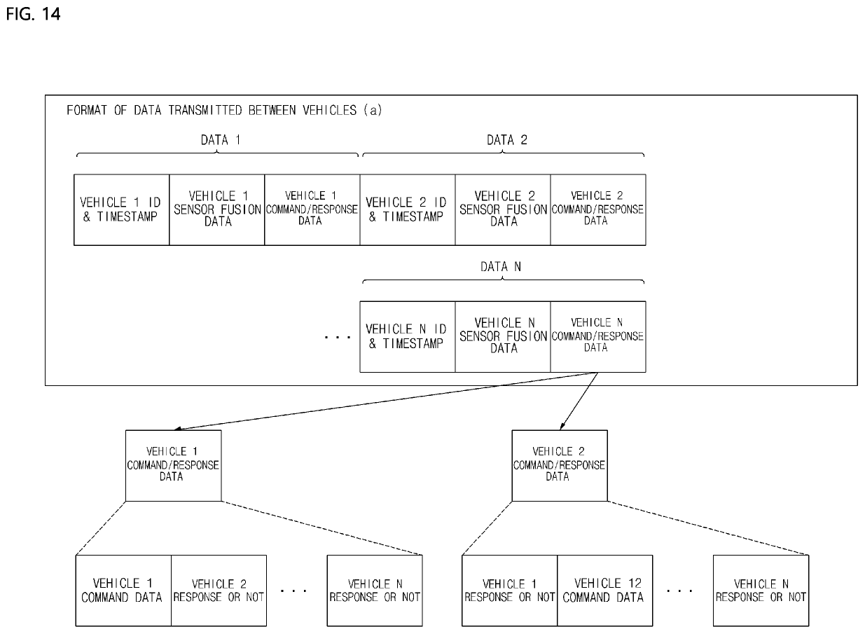

Referring to FIG. 14, transmission data transmitted and received between vehicles may further include command data and response data of each other in addition ID data, timestamp data, and fusion data of each vehicle. Transmission data based on a specific time may be generated in numbers corresponding to the number of vehicles constituting a platoon, and all of the vehicles constituting the platoon may share transmission data generated in numbers corresponding to the number thereof.

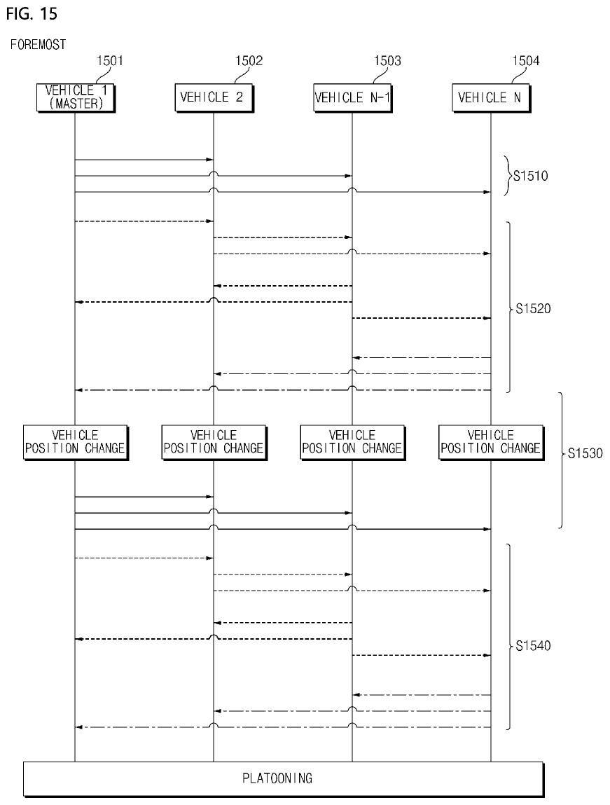

Referring to FIG. 15, a platooning system may include a first vehicle 1501, a second vehicle 1502, a third vehicle 1503, and a fourth vehicle 1504. The first vehicle 1501 may be classified as a vehicle 10, and the second vehicle 1502, the third vehicle 1503, and the fourth vehicle 1504 may be classified as other vehicles. Meanwhile, an operation of generating data, an operation of transmitting data, and an operation of receiving data may be performed by the processor 170 of the electronic device 100 for vehicles.

When a button of the master vehicle 1501 for platooning is turned on, the master vehicle 1501 may transmit fusion data and position data to the other vehicles. The master vehicle 1501 may overtake the other vehicles, or the other vehicles make way for the master vehicle such that the master vehicle 1501 moves to the head. Vehicle ID numbers may be assigned to the slave vehicles 1502, 1503, and 1504 in the sequence close to the master vehicle 1501, and the slave vehicles may move to their own positions based on the ID numbers. When the platooning mode of all of the vehicles is completed, the master vehicle 1501 may start traveling.

The first vehicle 1501 may broadcast a master/slave registration mode notification message to the second vehicle 1502, the third vehicle 1503, and the fourth vehicle 1504 (S1510). In this case, the first vehicle 1501 may transmit the master and slave registration mode to the second vehicle 1502, the third vehicle 1503, and the fourth vehicle 1504 in the state of including fusion data and vehicle position data.

The second to fourth vehicles 1502, 1503, and 1504 may also broadcast the master/slave registration mode notification message received from the first vehicle 1501 (S1520).

High-priority vehicle ID number may be assigned to the master vehicle 1501, and vehicle ID numbers may be assigned in the sequence close to the master vehicle 1501 (S1530). After ID numbers are assigned, the vehicles may move behind the master vehicle 1501 in the sequence of numbers.

When platooning is ready, each of the vehicles 1501, 1502, 1503, and 1504 may broadcast a ready message (S1540). Upon receiving the ready message from all of the vehicles, the master vehicle 1501 may start traveling.

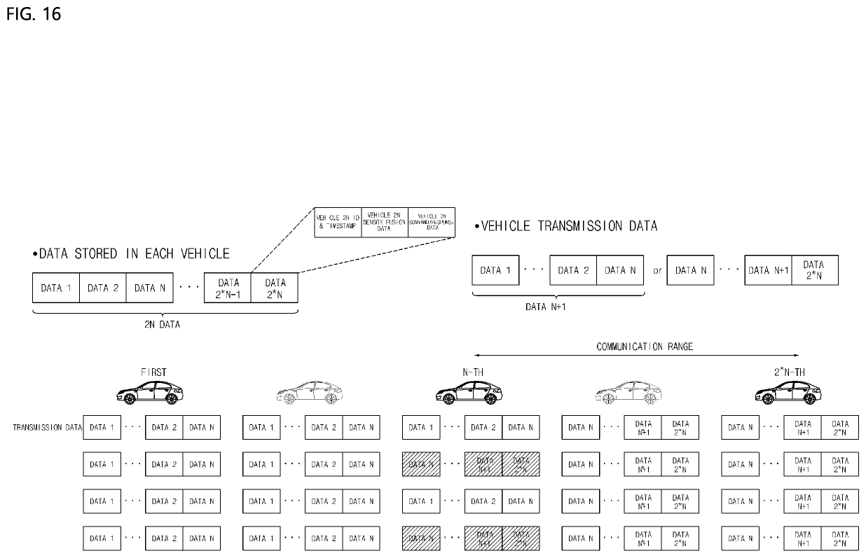

Referring to FIG. 16, in the case in which the number of vehicles constituting a platooning group is small, communication may be performed using the above described scheme. FIG. 16 exemplarily shows a communication scheme in the case in which the number of vehicles constituting a platooning group is large. On the assumption that the number of vehicles constituting a platooning group is 2N, 2N data must be broadcast. In the case in which the number of vehicles is increased, the number of data to be broadcast is also increased, whereby transmission and reception time may be increased. In this case, data may be transmitted and received N by N, and an N-th vehicle from the foremost of the platoon may serve as a bridge. The vehicle serving as the bridge may alternately broadcast data information of from a first vehicle (the foremost vehicle) to the N-th vehicle and data information of from the N-th vehicle to a 2N-th vehicles (the rearmost vehicle).

In the case in which the platooning group is constituted by N vehicles, the vehicles constituting the platooning group may perform communication using the above described scheme. In the case in which the platooning group is constituted by 2N vehicles, data may be grouped into two parts, and an N-th vehicle may serve as a bridge. In the case in which the platooning group is constituted by 3N vehicles, data may be grouped into three parts, and an N-th vehicle and a 2N-th vehicle may serve as bridges.

Meanwhile, N may be understood as the number of reference vehicles capable of directly communicating with each other without a communication bridge in a platoon.

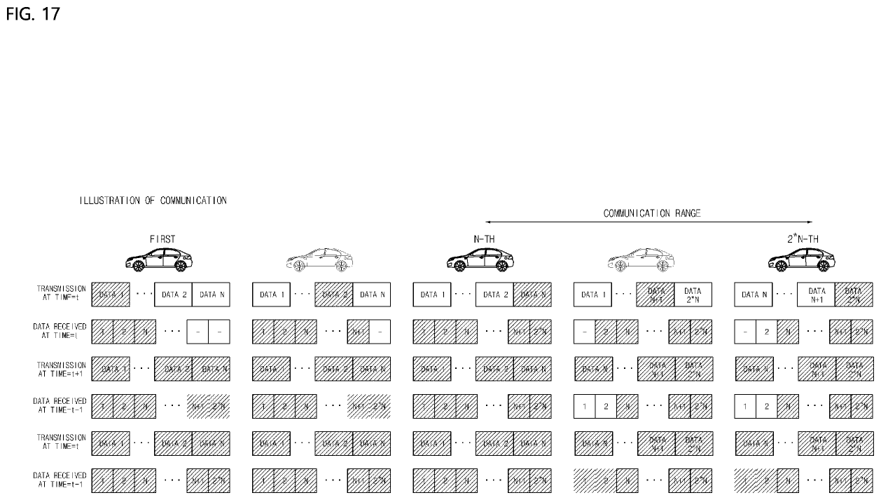

Referring to FIG. 17, in the case in which the number of vehicles that serve as bridges is two or more, the vehicles serving as the bridges may alternately transmit platooned data, whereby latency of data may be reduced.

The present disclosure as described above may be implemented as code that can be written on a computer-readable medium in which a program is recorded and thus read by a computer. The computer-readable medium includes all kinds of recording devices in which data is stored in a computer-readable manner. Examples of the computer-readable recording medium may include a hard disk drive (HDD), a solid state disk (SSD), a silicon disk drive (SDD), a read only memory (ROM), a random access memory (RAM), a compact disk read only memory (CD-ROM), a magnetic tape, a floppy disc, and an optical data storage device. In addition, the computer-readable medium may be implemented as a carrier wave (e.g. data transmission over the Internet). In addition, the computer may include a processor or a controller. Thus, the above detailed description should not be construed as being limited to the embodiments set forth herein in all terms, but should be considered by way of example. The scope of the present disclosure should be determined by the reasonable interpretation of the accompanying claims and all changes in the equivalent range of the present disclosure are intended to be included in the scope of the present disclosure.

### DESCRIPTION OF REFERENCE NUMERALS

10: Vehicle
100: Electronic device for vehicles

1. An electronic device for vehicles included in a vehicle that functions as a lead vehicle during platooning, the electronic device comprising:
a processor configured:
to classify acquired information based on use thereof;
upon determining that the information is first information used in platooning, to assign processing of the first information to a first processor; and
upon determining that the information is second information used in monitoring of a platoon, to assign processing of the second information to a second processor.

2. The electronic device according to claim 1, wherein the processor is configured:
to transmit the first information to at least one other vehicle in the platoon and to receive a first signal corresponding to the first information from the other vehicle through a first signal scheme; and
to transmit the second information to the other vehicle and to receive a second signal corresponding to the second information from the other vehicle through a second signal scheme different from the first signal scheme.

3. The electronic device according to claim 1, wherein the processor is configured to use the first information in at least one of an operation of generating an autonomous traveling route, an operation of detecting an object outside the platoon, or an operation of generating 3D map data.

4. The electronic device according to claim 1, wherein the processor is configured to use the second information in at least one of an operation of adjusting a distance between vehicles in the platoon or an operation of determining whether a control command is reflected.

5. The electronic device according to claim 1, wherein
the first information is generated based on at least some of first sensing data generated by a first sensor, and
the second information is generated based on at least some of the first sensing data generated by the first sensor.

6. The electronic device according to claim 1, wherein the processor is configured to transmit at least one of the first information or the second information to a server and to receive result data generated as a result of processing the transmitted information from the server.

7. The electronic device according to claim 1, wherein, upon determining that a condition of the platoon is changed, the processor reclassifies information acquired after the condition of the platoon is changed, based on use thereof.

8. The electronic device according to claim 1, wherein the processor is configured to fuse sensing data received from a plurality of sensors and sensing data of another vehicle received through a communication device in order to acquire information.

9. The electronic device according to claim 1, wherein the processor is configured:
to add vehicle ID data and timestamp data to the first information in order to generate first transmission data by the first processor; and
to add the vehicle ID data and the timestamp data to the second information in order to generate second transmission data by the second processor.

10. The electronic device according to claim 9, wherein the processor is configured to broadcast the first transmission data and the second transmission data.

11. An operation method of an electronic device for vehicles included in a vehicle that functions as a lead vehicle during platooning, the operation method comprising:
classifying, by at least one processor, acquired information based on use thereof, wherein
the classifying comprises:
upon determining that the information is first information used in platooning, assigning processing of the first information to a first processor; and
upon determining that the information is second information used in monitoring of a platoon, assigning processing of the second information to a second processor.

12. The operation method according to claim 11, further comprising:
transmitting, by the at least one processor, the first information to at least one other vehicle in the platoon;
receiving, by the at least one processor, a first signal corresponding to the first information from the other vehicle through a first signal scheme;
transmitting, by the at least one processor, the second information to the other vehicle; and
receiving, by the at least one processor, a second signal corresponding to the second information from the other vehicle through a second signal scheme different from the first signal scheme.

13. The operation method according to claim 11, further comprising using, by the at least one processor, the first information in at least one of an operation of generating an autonomous traveling route, an operation of detecting an object outside the platoon, or an operation of generating 3D map data.

14. The operation method according to claim 11, further comprising using, by the at least one processor, the second information in at least one of an operation of adjusting a distance between vehicles in the platoon or an operation of determining whether a control command is reflected.

15. The operation method according to claim 11, wherein
the first information is generated based on at least some of first sensing data generated by a first sensor, and
the second information is generated based on at least some of the first sensing data generated by the first sensor.

16. The operation method according to claim 11, further comprising:
transmitting, by the at least one processor, at least one of the first information or the second information to a server; and
receiving, by the at least one processor, result data generated as a result of processing the transmitted information from the server.

17. The operation method according to claim 11, further comprising reclassifying, by the at least one processor, upon determining that a condition of the platoon is changed, information acquired after the condition of the platoon is changed based on use thereof.

18. The operation method according to claim 11, further comprising fusing, by the at least one processor, sensing data received from a plurality of sensors and sensing data of another vehicle received through a communication device in order to acquire information.

19. The operation method according to claim 11, further comprising:
adding, by the first processor, vehicle ID data and timestamp data to the first information in order to generate first transmission data; and
adding, by the second processor, the vehicle ID data and the timestamp data to the second information in order to generate second transmission data.

20. The operation method according to claim 19, further comprising:
broadcasting, by the at least one processor, the first transmission data; and
broadcasting, by the at least one processor, the second transmission data.
